(19) United States
(12) Patent Application Publication
(10) Pub. No.: US 2016/0201457 A1
(43) Pub. Date: Jul. 14, 2016

(54) Downhole Rebound Hardness Measurement While Drilling or Wireline Logging

(71) Applicants: David A. Curry, Askett (GB); Javier A. Franquet, Abu Dhabi (AE); Michael M. Reese, Houston, TX (US)

(72) Inventors: David A. Curry, Askett (GB); Javier A. Franquet, Abu Dhabi (AE); Michael M. Reese, Houston, TX (US)

(73) Assignee: BAKER HUGHES INCORPORATED, Houston, TX (US)

(21) Appl. No.: 15/077,463

(22) Filed: Mar. 22, 2016

Related U.S. Application Data
(63) Continuation-in-part of application No. 13/050,660, filed on Mar. 17, 2011, now Pat. No. 9,291,539.

(51) Int. Cl. E21B 49/00; G06F 17/50; E21B 7/06; G01V 99/00; G01N 3/48; G01V 9/00

(52) U.S. Cl. CPC E21B 49/00; G01N 3/48; G01V 9/00; E21B 7/06; G01V 99/005; G06F 17/50

(57) ABSTRACT

A method of obtaining a hardness profile of a formation is disclosed. A testing surface in a wellbore impacts the formation to obtain a measurement of formation hardness. A lithological property of the formation is measured and used in determining the rock strength of the formation from the formation hardness. The testing surface may be propelled at the formation a plurality of times to obtain a profile of rock hardness measurements with distance into the formation, including at a surface layer of the formation. Alternatively, the testing surface can be propelled at the formation at multiple energies to obtain formation properties at a plurality of depths into the formation, including at a surface layer of the formation. The rock strength may be used with measurements of geomechanical stress and pore pressure to build a model of the formation in order to develop the formation.

### CROSS-REFERENCE TO RELATED APPLICATIONS

The present application is a continuation-in-part of U.S. patent application Ser. No. 13/050,660, filed Mar. 17, 2011.

### BACKGROUND OF THE DISCLOSURE

1. Field of the Disclosure

The present disclosure is related to methods and apparatus for estimating a parameter of a downhole formation and, in particular, to determining the parameter of the wellbore using a rebound hardness device.

2. Description of the Related Art

In petroleum exploration, drilling a wellbore or borehole in an earth formation employs a drill string with a drill bit at an end of the drill string. The speed and effectiveness of drilling is determined in part on the type of rock that is being drilled and its hardness or strength. Various types of rock that can be drilled can range from hard rocks such as granites and dolomites to soft rocks such as sandstones and shales. Various devices for estimating rock hardness are known in the art. However, these require obtaining a core sample and retrieving the sample to a surface location for testing, which can be time-consuming and expensive. Therefore, the present disclosure provides a method and apparatus for estimating in-situ a rock strength profile of a formation.

### SUMMARY OF THE DISCLOSURE

In accordance with one embodiment, the present disclosure provides a method of estimating a rock strength of a formation, including: conveying a tool having a testing surface into a wellbore in the formation; propelling the testing surface from the tool along a selected direction to impact the formation; obtaining a measurement of hardness of the formation from a rebound of the testing surface from the formation; measuring a value of a lithological property of the formation using a downhole sensor; using the value of the lithological property of the formation to select a relation between the selected rock hardness and the rock strength of the formation; and determining the rock strength of the formation from the measurement of rock hardness and the selected relation between the rock hardness and rock strength.

In accordance with another embodiment, the present disclosure provides a method of developing a formation, including: determining a rock strength of the formation at a selected location in a wellbore from a rock hardness measurement obtained by propelling a testing surface at the selection location; obtaining a measurement of geomechanical stress and a measurement of pore pressure at the selected location; and using a processor to: build a model of the formation using the rock strength, the geomechanical stress and the pore pressure at a plurality of depths, and develop the formation using the model of the formation.

In accordance with another embodiment, the present disclosure provides a method of determining a property of a formation, including: propelling the testing surface from a tool in a wellbore a plurality of times to impact the formation at a selected location, wherein the formation includes a surface layer at an interface of the formation and the wellbore; for each of the plurality of impacts, obtaining a measurement of hardness of the formation at the selected location in the wellbore; obtaining a profile of rock hardness measurements with distance into the formation from the plurality of measurements of hardness; and determining the property of the surface layer from a first subset of the measurements of hardness and the property of the formation from a second subset of the plurality of hardness measurements.

In accordance with yet another embodiment, the present disclosure provides a method of obtaining a hardness profile of a formation, including: propelling a testing surface in a wellbore penetrating the formation to impact the formation at a selected location at a first energy to obtain a first rock hardness measurement at the selected location; propelling the testing surface to impact the formation at the selected location at a second energy to obtain a second rock hardness measurement at the selected location; and determining a property of a surface layer on a wall of the wellbore at the selection location from the first rock hardness measurement and a property of the formation at the selection location from the second rock hardness measurement.

Examples of certain features of the apparatus and method disclosed herein are summarized rather broadly in order that the detailed description thereof that follows can be better understood. There are, of course, additional features of the apparatus and method disclosed hereinafter that will form the subject of the claims.

### BRIEF DESCRIPTION OF THE DRAWINGS

For detailed understanding of the present disclosure, references should be made to the following detailed description, taken in conjunction with the accompanying drawings, in which like elements have been given like numerals and wherein:

FIG. 1 is a schematic diagram of an exemplary drilling system that includes a drill string having a drilling assembly attached to its bottom end that can be operated according to the exemplary methods apparatus disclosed herein;

FIG. 2 shows an exemplary rock hardness measurement device (RHMD) suitable for use in the exemplary system of the present disclosure;

FIG. 3A shows a typical piston tip used in obtaining rock hardness measurements.

FIG. 3B shows an exemplary piston tip suitable for use in obtaining rock hardness measurements in a wellbore;

FIG. 4A shows a section of a downhole tool having an exemplary downhole RHMD according to one embodiment of the present disclosure;

FIG. 4B shows another exemplary embodiment of the present disclosure which includes a plurality of RHMDs circumferentially spaced about the tool;

FIG. 4C shows a cross-section of a horizontal wellbore having a tool therein for obtain rebound hardness measurements in directions parallel and perpendicular to a formation bedding;

FIG. 5 shows an exemplary chart suitable for estimating rock strength of a formation using hardness measurements obtained at a downhole location;

FIGS. 6A-6D show various charts for estimating rock strength of a formation using a variety of parameter measurements of the formation;

FIG. 7 shows a schematic diagram illustrating a method for determining a wellbore integrity using rock hardness measurements;

FIG. 8 shows a drill string assembly for determining a rock strength profile at a selected location of a wellbore in the formation;

FIGS. 9A and 9B show illustrative relations between measured rock hardness values and numerical order of rock hardness tests for the drill string assembly of FIG. 8; and

FIG. 10 shows a plot of between rock hardness values vs. kinetic energy of the piston of a rock hardness measurement device.

### DETAILED DESCRIPTION OF THE DISCLOSURE

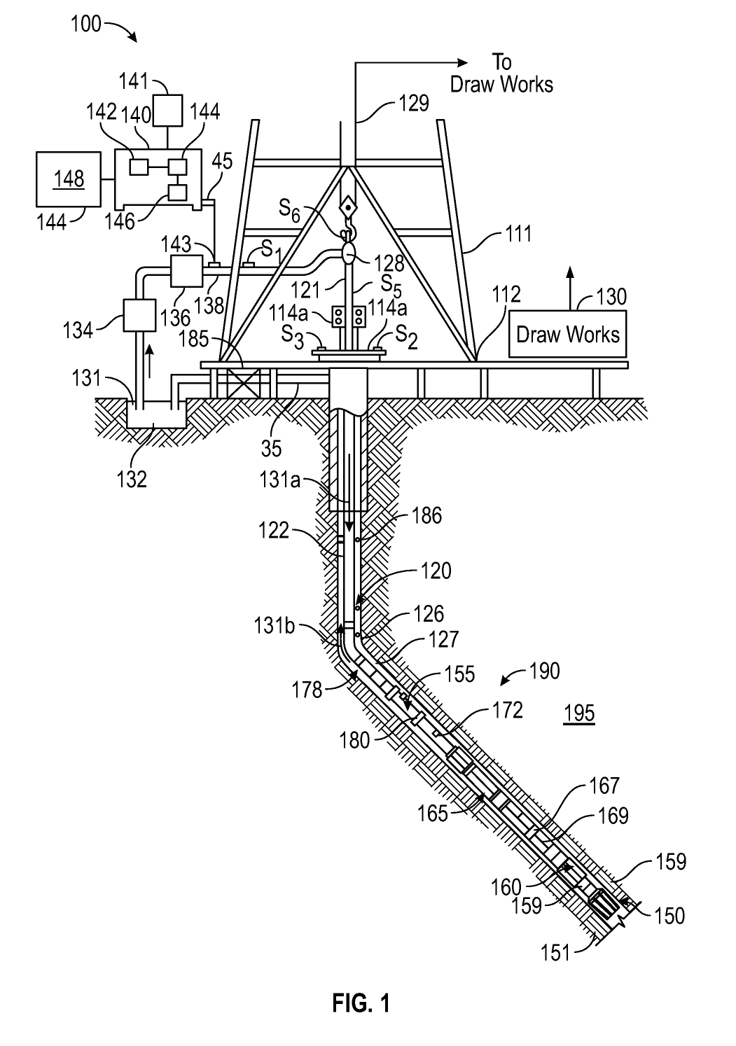

FIG. 1 is a schematic diagram of an exemplary drilling system 100 that includes a drill string having a drilling assembly attached to its bottom end that can be operated according to the exemplary methods apparatus disclosed herein. FIG. 1 shows a drill string 120 that includes a drilling assembly or bottomhole assembly (“BHA”) 190 conveyed in a wellbore 126. The drilling system 100 includes a conventional derrick 111 erected on a platform or floor 112 which supports a rotary table 114 that is rotated by a prime mover, such as an electric motor (not shown), at a desired rotational speed. A tubing (such as jointed drill pipe) 122 having the drilling assembly 190 attached at its bottom end extends from the surface to the bottom 151 of the wellbore 126. A drill bit 150, attached to drilling assembly 190, disintegrates the geological formations when it is rotated to drill the wellbore 126. The drill string 120 is coupled to a drawworks 130 via a Kelly joint 121, swivel 128 and line 129 through a pulley. Drawworks 130 is operated to control the weight on bit (“WOB”). The drill string 120 can be rotated by a top drive (not shown) instead of by the prime mover and the rotary table 114. The operation of the drawworks 130 is known in the art and is thus not described in detail herein.

In an aspect, a suitable drilling fluid 131 (also referred to as “mud”) from a source 132 thereof, such as a mud pit, is circulated under pressure through the drill string 120 by a mud pump 134. The drilling fluid 131 passes from the mud pump 134 into the drill string 120 via a de-surger 136 and the fluid line 138. The drilling fluid 131a from the drilling tubular discharges at the wellbore bottom 151 through openings in the drill bit 150. The returning drilling fluid 131b circulates uphole through the annular space 127 between the drill string 120 and the wellbore 126 and returns to the mud pit 132 via a return line 135 and drill cutting screen 185 that removes the drill cuttings 186 from the returning drilling fluid 131b. A sensor S₁ in line 138 provides information about the fluid flow rate. A surface torque sensor S₂ and a sensor S₃ associated with the drill string 120 provide information about the torque and the rotational speed of the drill string 120. Rate of penetration of the drill string 120 can be determined from the sensor S₅, while the sensor S₆ can provide the hook load of the drill string 120.

In some applications, the drill bit 150 is rotated by rotating the drill pipe 122. However, in other applications, a downhole motor 155 (mud motor) disposed in the drilling assembly 190 also rotates the drill bit 150. The rate of penetration (“ROP”) for a given drill bit and BHA largely depends on the WOB or the thrust force on the drill bit 150 and its rotational speed.

A surface control unit or controller 140 receives signals from downhole sensors and devices via a sensor 143 placed in the fluid line 138 and signals from sensors S₁-S₆ and other sensors used in the system 100 and processes such signals according to programmed instructions provided from a program to the surface control unit 140. The surface control unit 140 displays desired drilling parameters and other information on a display/monitor 141 that is utilized by an operator to control the drilling operations. The surface control unit 140 can be a computer-based unit that can include a processor 142 (such as a microprocessor), a storage device 144, such as a solid-state memory, tape or hard disc, and one or more computer programs 146 in the storage device 144 that are accessible to the processor 142 for executing instructions contained in such programs to perform the methods disclosed herein. The surface control unit 140 can further communicate with a remote control unit 148. The surface control unit 140 can process data relating to the drilling operations, data from the sensors and devices on the surface, and data received from downhole and can control one or more operations of the downhole and surface devices. Alternately, the methods disclosed herein can be performed at a downhole processor 172.

The drilling assembly 190 also contains formation evaluation sensors or devices (also referred to as measurement-while-drilling, “MWD,” or logging-while-drilling, “LWD,” sensors) determining resistivity, density, porosity, permeability, acoustic properties, nuclear-magnetic resonance properties, corrosive properties of the fluids or formation downhole, salt or saline content, and other selected properties of the formation 195 surrounding the drilling assembly 190. Such sensors are generally known in the art and for convenience are generally denoted herein by numeral 165. The drilling assembly 190 also includes one or more Rock Hardness Measurement Devices (RHMDs) 167 for obtaining a rebound hardness measurement that may be used to estimate rock strength profile of a formation according to the exemplary methods disclosed herein. The drilling assembly 190 can further include a variety of other sensors and communication devices 159 for controlling and/or determining one or more functions and properties of the drilling assembly (such as velocity, vibration, bending moment, acceleration, oscillations, whirl, stick-slip, etc.) and drilling operating parameters, such as weight-on-bit, fluid flow rate, pressure, temperature, rate of penetration, azimuth, tool face, drill bit rotation, etc. In addition, the drilling assembly 190 can also include one or more accelerometers 169 or equivalent devices for estimating an orientation of the drill string and of the one or more rock hardness measurement devices (RHMD) 167 in the wellbore. A suitable telemetry sub 180 using, for example, two-way telemetry, is also provided as illustrated in the drilling assembly 190 and provides information from the various sensors and to the surface control unit 140.

The surface control unit 140 may therefore receive measurements of rock hardness from the RHMD 167 as well as various measurements of formation parameters, which may include resistivity, density, porosity, permeability, acoustic properties, nuclear-magnetic resonance properties, corrosive properties of the fluids or formation downhole, salt or saline content, gamma-ray measurements, etc., from sensors 165. The surface control unit 140 can then determine models of the formation, including lithological models, which can be used to determine wellbore integrity, develop the wellbore, select a location for hydraulic fracturing, etc.

Still referring to FIG. 1, the drill string 120 further includes energy conversion device 160. In an aspect, the energy conversion device 160 is located in the BHA 190 to provide an electrical power or energy, such as current, to sensors 165, RHMD 167 and/or communication devices 159. Energy conversion device 160 can include a battery or an energy conversion device that can for example convert or harvest energy from pressure waves of drilling mud which are received by and flow through the drill string 120 and BHA 190. Alternately, a power source at the surface can be used to power the various equipment downhole. While the tool 420 for measuring rock hardness is shown her as incorporated into the BHA 190 and conveyed into the wellbore 126 as part of the drill string 120, it is to be understood that in another embodiment, the tool 420 can be conveyed into the wellbore 126 on a conductive cable (i.e., wireline), a coiled tubing or other suitable device.

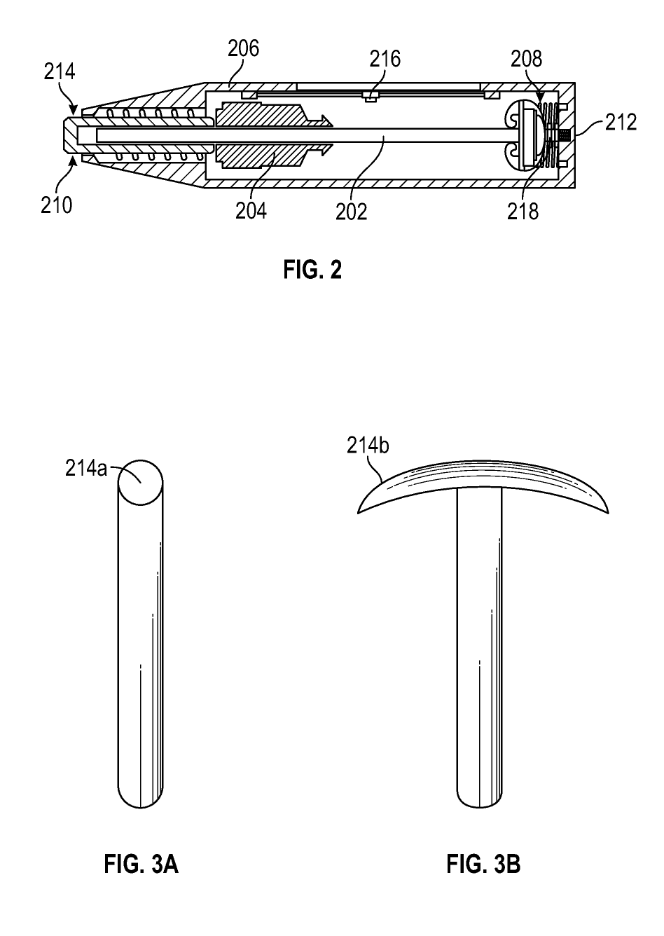

FIG. 2 shows an exemplary rock hardness measurement device (RHMD) 167 suitable for use in the exemplary system of the present disclosure. In an exemplary embodiment, the RHMD is a Schmidt Hammer tool known in the art for non-destructive testing and for measuring strength of various structures such as bridges, dams, foundation, etc. The exemplary RHMD 167 includes a piston 202 with an affixed hammer mass 204. The piston is configured to slide in and out of casing 206 through opening 210 at one end of the RHMD. The piston can reside in a retracted position within the casing 206 by compressing the compression spring 208 against end 212 of the RHMD opposite the opening 210. The piston and compression spring are held in the retracted position by a trip screw 218 in a first position. The trip screw 218 moves from the first position to a second position to release the compression spring, which upon being released propels the piston 202 outward from opening 210. The RHMD 167 in one aspect propels the piston 202 at a surface of a test material. Piston 202 has a tip 214 having a surface configured to impact and rebound from the test material. The amount of rebound of the piston/tip from the test material is measured to obtain the hardness of the test material. In one aspect, rebound measuring unit 216 obtains a measure of the rebound and creates an electronic or digital signal indicating the measured rebound and/or the hardness of the material. The created signal can be sent to a processor coupled to the RHMD 167. The processor can use the measured hardness of the material to estimate rock strength of the tested material. In various embodiments, the RHMD 167 includes means for resetting the piston in its retracted position and thus can be used at a downhole remote location from an operator. In alternative embodiments, the piston 202 can be set at different retracted positions so that upon the release the piston 202 moves the affixed hammer mass 204 to impact a surface with different kinetic energies. The kinetic energy upon impact is a function of the retracted position at which the piston 202 is set and the spring constant of compression spring 208.

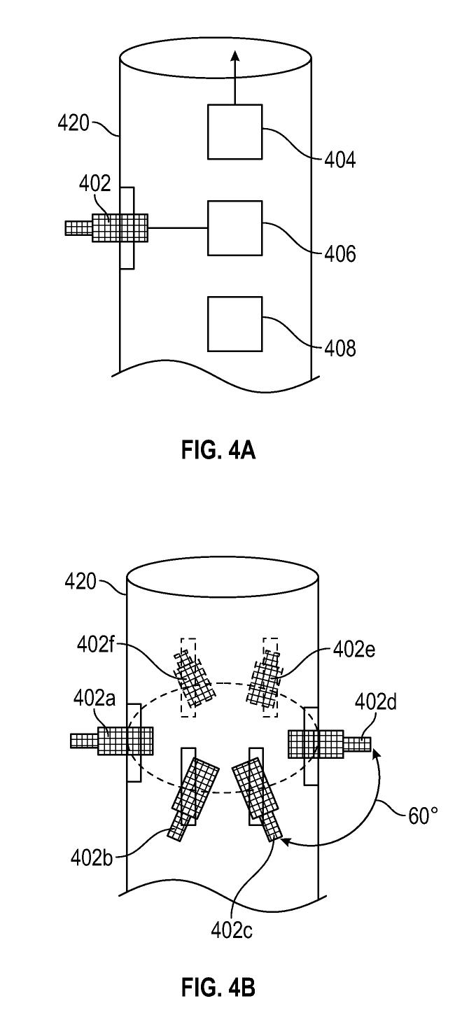

In one embodiment, the tip is configured to obtain a hardness measurement in a wellbore. FIG. 3A shows a typical piston tip 214a used in rock hardness testing. Tip 214a is typically a surface of a hemisphere having a diameter of approximately 1 cm. However, wellbore surfaces can be rough due to natural rock surfaces, washout and other forces. Therefore, the tip 214a of FIG. 3A can slip along the wellbore surface or otherwise poorly impact the wellbore surface. The present disclosure therefore provides a piston having a tip 214b (FIG. 3B) configured to impact the wellbore surface without slipping. In one embodiment, tip 214b is a surface of a sphere having a radius of curvature of approximately 10 cm. Tip 214b is therefore able to impact a rough surface and not slip against it. Additionally, the cross-section of the tip 214b is greater than the cross-section of tip 214a, as shown in FIGS. 3A and 3B. Therefore, the impact area of tip 214b is greater than the impact area of tip 214a. The geometry of the tip 214b enables acquisition of the rebound hardness number in mud cake zones, highly fractured zones and highly weather areas. In addition, tip 214b is applicable on rough or curved wellbore surfaces having dented or concaved irregularities.

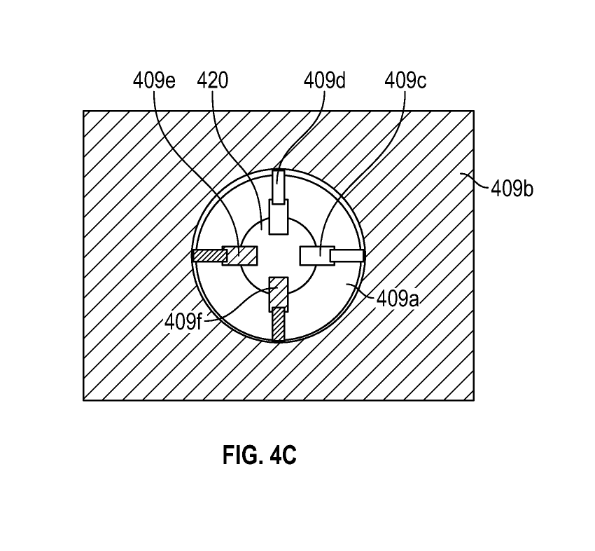

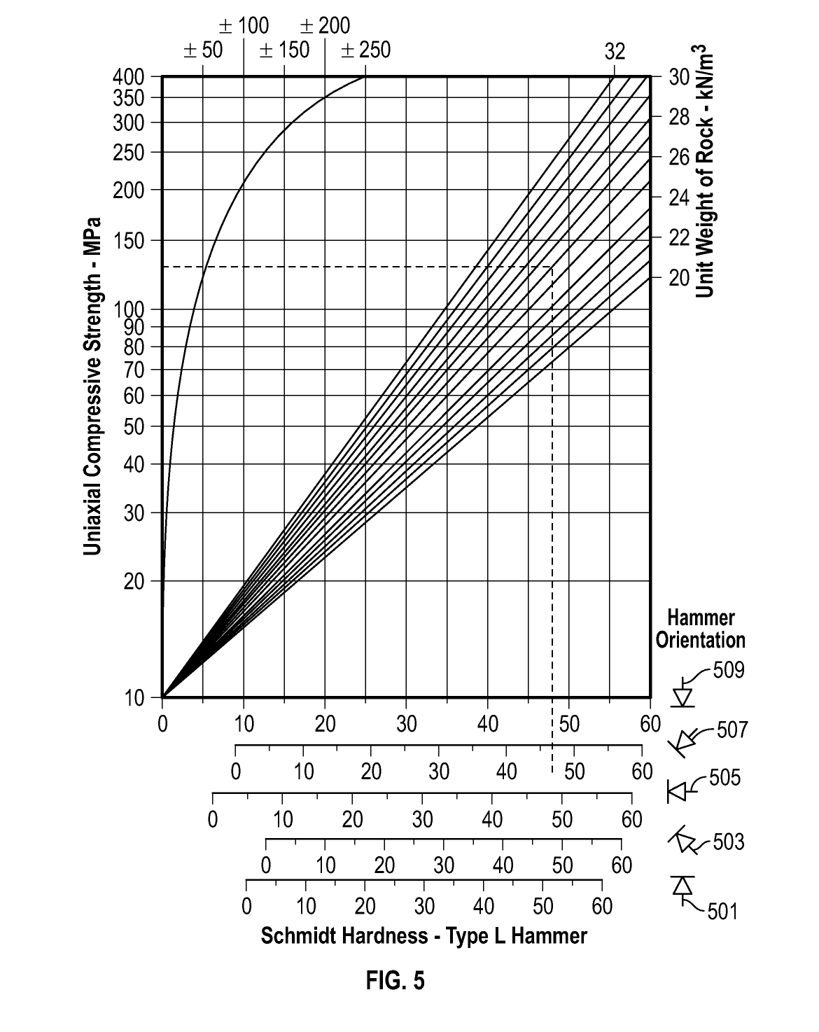

FIG. 4A shows a section of a downhole tool 420 having an exemplary downhole RHMD 402 according to one embodiment of the present disclosure, such as the RHMD of FIG. 2. The tool 420 and its RHMD 402 are conveyed downhole with bottomhole assembly 190 and pressed against a surface of the wellbore. The RHMD 402 is activated to propel the piston and tip against the wellbore surface to thereby obtain a rock hardness measurement. RHMD 402 is coupled to processor 406, which can receive the obtained rock hardness measurement from the RHMD 402 and estimate rock strength of the formation at the location. Additionally, a rock strength profile can be estimated at processor 406. An orientation device 408 provides orientation of the drill string and/or RHMD 402 to processor 406. Orientation of the RHMD 402 affects the measurements obtained of rock hardness. For example, a horizontal placement of the RHMD 402 wherein the piston is propelled horizontally is substantially unaffected by gravitational force. However, if the piston is propelled in a direction that has a vertical component (i.e., vertical direction), the gravitational force affects the acceleration of the piston and therefore the impact of the piston has against a material to be tested. If the RHMD 402 is oriented so that the piston is propelled downward to the test surface, the piston impacts the test surface with more energy. If the RHMD 402 is oriented so that the piston is propelled upward to the test surface, the piston impacts the test surface with less energy. Processor 406 therefore computes rock strength using the obtained hardness measurements from the RHMD 402 and an orientation of the RHMD 402, as discussed below with respect to FIG. 5. In one embodiment, computed rock strength can be sent to a surface location using telemetry device 404 for calculations at surface control unit 140.

FIG. 4B shows another exemplary embodiment of the present disclosure which includes a plurality of RHMDs 402a-402f circumferentially spaced about the tool 420. Although six RHMDs are shown for illustrative purposes, the number of RHMDs is not meant as a limitation of the present disclosure. Referring to FIG. 2B, six exemplary RHMDs are spaced at 60° along the circumference of tool 420. The circumferentially-spaced RHMDs 402a-402f enable an operator to obtain measurements of rock hardness at various azimuthal locations around the tool. In an alternate method of obtaining rock hardness measurements at a plurality of azimuthal locations, the single RHMD 402 of FIG. 4A can be rotated to the circumferential positions of RHMDs 402a-402f and activated to obtain measurements at each location. Both tools of FIG. 4A and FIG. 4B can be moved axially to obtain hardness measurements at a plurality of depths of the wellbore. The hardness measurements at the plurality of depths can be used to obtain a rock strength profile of the formation. Typically hardness measurements are obtained at various depths of the wellbore.

The rock strength profile can be measured at a single azimuthal location or can be measured at a plurality of azimuthal locations to obtain two- and three-dimensional rock strength profiles. In highly deviated and horizontal wells and wellbores, the plurality of azimuthal harness measurements will quantify the transverse stiffness and hardness anisotropy of horizontally laminated formations. Measurements of rock stiffness, hardness and strengths vary depending of the relative inclination between the loading direction and bedding plane. For example FIG. 4C, illustrates a horizontal wellbore 409a drilled into a horizontally laminated rock 409b (such as a shale formation). Tool 420 includes RHMDs 409c, 409d, 409e and 409f for performing hardness measurements in orthogonal direction. RHMDs 409c and 409e perform measurements in a direction parallel to the beddings and/or laminations of the formation 409b. RHMDs 409d and 409f perform measurements in a direction perpendicular to the beddings and/or laminations. The measurements parallel to the bedding are performed horizontally (to the left 409c or to the right 409e side of the horizontal wellbore 409a), while the measurements perpendicular to the bedding are performed vertically, either in an upward direction 409d towards the high side of the wellbore 409a or in a downward direction 409f towards the low side of the wellbore 409a. Since the high and low side of the wellbore 409a are in contact with the same rock type, the difference of rebound hardness between the 409d and 409f measurements may be used to quantify the effect of gravity in the hardness measurement.

In various embodiments, the exemplary RHMDs obtain measurements at a particular location in the wellbore by obtaining multiple measurements at the location and nearby locations and averaging values. A maximum and minimum measurement at the particular location may be disregarded and an average taken of the remaining values. Impacting the wellbore formation at the particular location generally affects subsequent rock hardness measurements. Therefore, subsequent measurements related to the particular location can be obtained by moving the RHMD device to a nearby location which may be at a distance of between 10 cm and 30 cm.

In one embodiment, the RHMDs of FIGS. 4A and 4B are conveyed within a compartment within tool 420 to the downhole location and are extended from the compartment to obtain rock hardness measurements. In another aspect, the RHMDs are conveyed on pads coupled to tool 420. The pads can be extended from the tool to abut the RHMDs against the wellbore to obtain rock hardness measurements. Although not shown in FIG. 4B, RHMDs 402a-402f can be coupled to one or more orientation devices for estimating orientations of the RHMDs and to a processor for estimating rock strength from obtained rock hardness measurements and orientation measurements. Also, a telemetry device can provide estimated values to a surface location.

FIG. 5 shows an exemplary chart 500 for estimating rock strength of a formation using hardness measurements obtained at a downhole location. Multiple rock hardness scales 501, 503, 505, 507 and 509 are shown along an x-axis. Each rock hardness scale corresponds to an orientation of an RHMD. Hence, scale 501 corresponds to a RHMD in a vertical orientation with the piston directed to be propelled downward. Scale 503 corresponds to the RHMD orientated at 45° to the downward vertical direction. Scale 505 corresponds to the RHMD oriented horizontally. Scale 507 corresponds to the RHMD oriented at 45° to an upward vertical direction. Scale 509 corresponds to the RHMD oriented vertically with the piston directed to be propelled upward. Uniaxial compressive strength (rock strength) is shown along the y-axis in MegaPascals. A plurality of rock density lines are shown along chart 500. Each rock density lines is related to density of various rock types, such as dolomite, granite, sandstone, shale rock, for example. Rock strength is estimated using an appropriate rock hardness scale and rock density. For example, a rock hardness of 48 is obtained at a RHMD which is oriented in a horizontal direction and for which the density of rock is 26 kN/m³. Rock density can be estimated using various methods such as acoustic measurements and/or gamma ray measurements. Rock density may also be measured using bulk density measurements or similarly measurements obtained using nuclear logging tools. Therefore, the number 48 is located on scale 505, which applied to a horizontally directed piston. Using the rock density line labeled 26 in FIG. 5, the rock strength is estimated to be about 140 MPa.

In various aspects, the obtained rock strength profile can be used to characterize in-situ wellbore stress conditions in real-time. The methods and apparatus can be used as part of a measurement-while-drilling device or in wireline logging and drilling parameters can be altered based on the rock strength profile. In general, sedimentary reservoir formations show high anisotropic effects because of several fracture networks such as bedding planes, joints, laminations, etc. Therefore, multiple orientations of rebound hardness measurements provide an improved measurement of wellbore strength compared to a single alignment of a rebound hardness measurement.

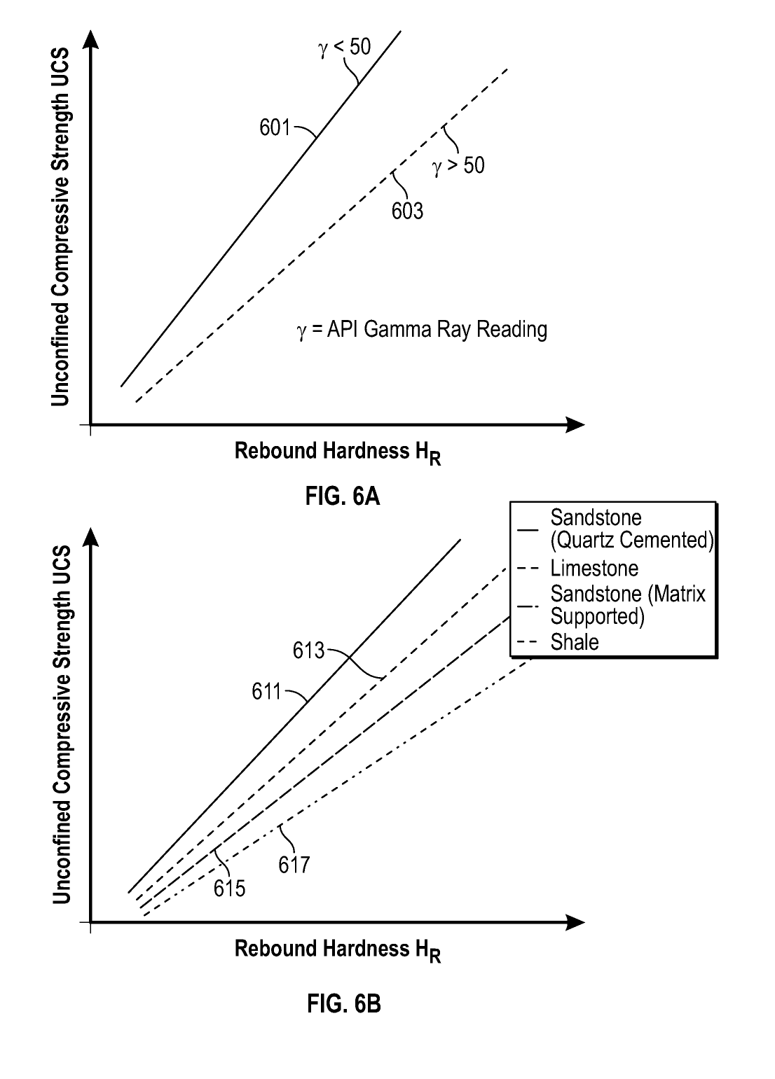

FIGS. 6A-6D show various charts for estimating rock strength of a formation using a variety of parameter measurements of the formation. FIG. 6A shows a chart for estimating rock strength profile from rock hardness using gamma ray measurements obtained from the formation. Rock strength (Unconfined Compressive Strength (UCS)) is shown along the y-axis and rebound hardness (H_{R}) is shown along the x-axis. Curves 601 and 603 show a relation between rock strength and rebound hardness for a given gamma ray measurement from the formation. Curve 601 shows a relation for gamma ray measurements less than 50 API and curve 603 shows a relation for gamma ray measurements greater than 50 API. Given a rebound hardness measurement obtained from the formation and a measurement of gamma rays from the formation, one can determine rock strength of the formation. While only two curves are shown, it is to be understood that more than two curves can be provided in alternate embodiments of the present invention, with each curve relating rock strength to rebound hardness based on a particular gamma ray measurement or range of gamma ray measurements.

FIG. 6B shows a chart for estimating rock strength profile from rock hardness based on a lithology of the formation. Rock strength (Unconfined Compressive Strength (UCS)) is shown along the y-axis and rebound hardness (H_{R}) is shown along the x-axis. Curves are shown for sandstone (quartz cemented) 611, limestone 613, sandstone (matrix supported) 615 and shale 617. Curves for additional formation lithologies can also be used, though they are not explicitly shown in FIG. 6B.

FIG. 6C shows a chart for estimating rock strength profile from rock hardness using acoustic measurements obtained from the formation. Rock strength (Unconfined Compressive Strength (UCS)) is shown along the y-axis and rebound hardness (H_{R}) is shown along the x-axis. The travel times and travel velocities can be measured for an acoustic signal transmitted into a formation. Curves for different travel times of the acoustic signal in the formation are shown in FIG. 6C and labelled as 50 μsec/ft, 70 μsec/ft, 90 μsec/ft, 110 μsec/ft and 130 μsec/ft. Additional acoustic velocities can also be represented in alternative embodiments of the present invention. Given a rebound hardness measurement obtained from the formation and a measurement of acoustic velocity of the formation, one can determine a rock strength of the formation.

FIG. 6D shows a chart for estimating rock strength profile from rock hardness using porosity measurements of the formation. Rock strength (Unconfined Compressive Strength (UCS)) is shown along the y-axis and rebound hardness (H_{R}) is shown along the x-axis. Formation porosity for the formation may be measured using downhole sensors. Curves are shown in FIG. 6D for porosity measurements of 0, 5, 10, 15 and 20. Curves for additional porosities may also be represented in alternative embodiments of the present invention. Given a rebound hardness measurement obtained from the formation and a measurement of formation porosity, one can determine a rock strength of the formation.

For any of FIGS. 6A-6D, the relationship between UCS and rebound hardness need not be a linear relationship and may be any type or form of curve. In one embodiment, multiple values of rock strength may be estimated using the methods disclosed with respect to FIGS. 5 and 6A-6D and a final rock strength value may be estimated from the multiple rock strengths, such as by averaging their values.

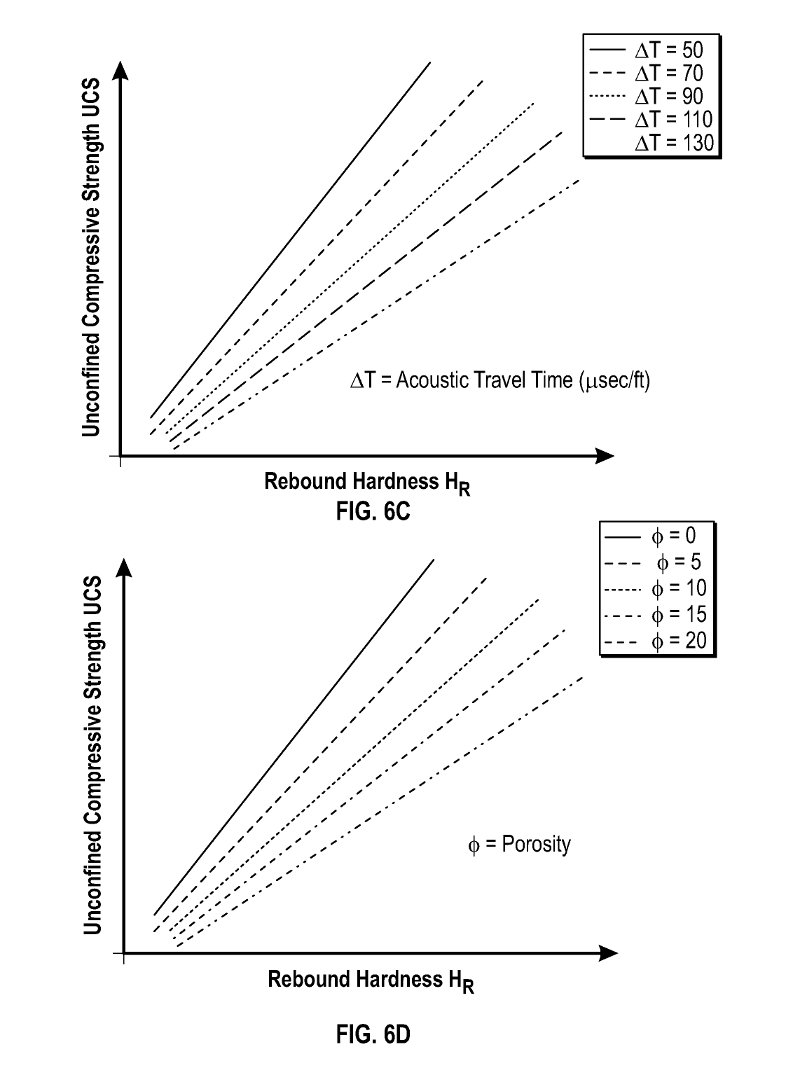

FIG. 7 shows a schematic diagram 700 illustrating a method for determining a wellbore integrity. Rock strength profile 702 is provided by one or more RHMD devices conveyed downhole. In one embodiment, the rock strength profile may be provided at a plurality of depths in the wellbore, thereby providing a log of rock strength vs. depth. Similarly, geo-mechanical stress measurements 704 may be obtained vs. depth. The geo-mechanical stress measurements 704 may be obtained via one or more sensors such as resistivity sensors, acoustic sensors, etc., that are conveyed downhole to a plurality of depths. Additionally, a pore pressure vs. depth may be measured using gamma-ray sensors employed downhole at a plurality of depths. The logs of rock strength profile 702, geo-mechanical stress 704 and pore pressure 706 may then be combined to form a formation model 708 of the wellbore and surrounding formation. The formation model 708 may then be used to determine a wellbore integrity which is useful in planning a completion process. Also, the formation model 708 may be used to develop a plan for hydraulic fracturing of the formation by estimating a location for at which the rock strength profile, geo-mechanical stress and pore pressure indicate a possible success in hydraulic fracturing in the wellbore. Additionally, the formation model 708 may be used for geo-steering of a drill string. In particular, the formation model 708 and/or the rock strength profile may be used to alter a drilling parameter in order to steer the drill string along a selected drill path. Alternatively, the drilling parameter may be altered to improve, affect or optimize a measure of drilling performance. The formation model 708 and/or rock strength profile may also be used to design at least one element of the drilling system 100, which may include the drill bit 150, the BHA 190 and/or the drilling fluid 131.

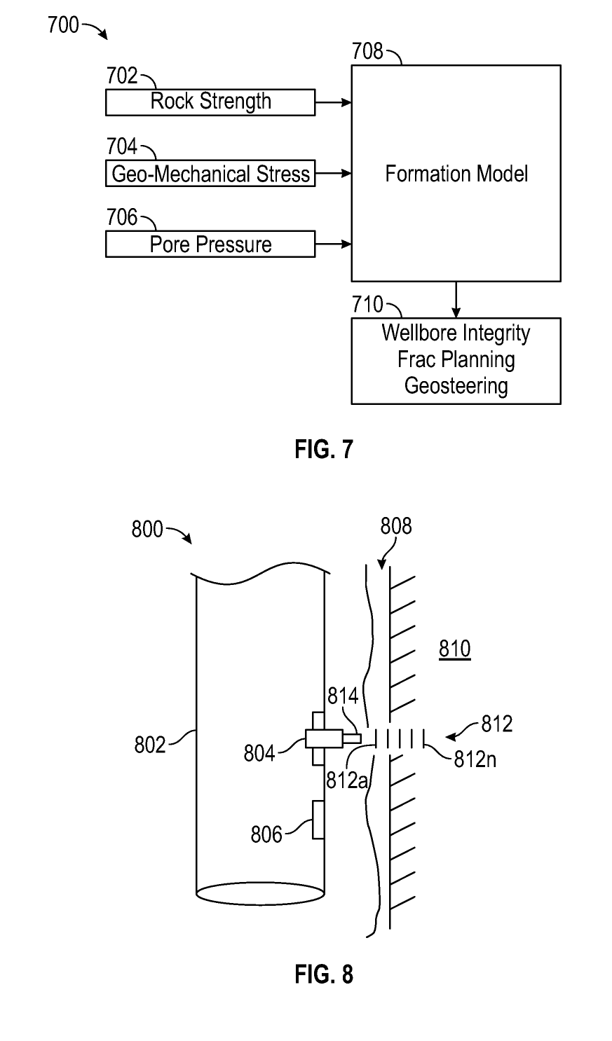

FIG. 8 shows a drill string assembly 800 for determining a rock strength profile at a selected location 812 of a wellbore in the formation 810. The selected location 812 may include a surface layer 808 of material on a wall of the formation 810. The surface layer 808 that may be an accumulation of drilling mud or may be a part of the formation that has been hydrated or otherwise conditioned due to its adjacency to the wellbore and consequent contact with fluid in the wellbore. The surface layer 808 generally has a hardness that is different that the hardness of the formation 810. In particular, the surface layer 808 is generally softer than the formation 810. The drill string assembly 800 includes a drill string 802 having one or more RHMDs 804 oriented to perform a rebound hardness measurement against a wall of the borehole. In one embodiment, the RHMD 804 performs a plurality of rock hardness tests at a selected location 812 by propelling the impact surface 814 at the selected location 812 for a plurality of times. Each subsequent rock hardness test obtains rock hardness measurements at progressively deeper depths (indicated by depths locations 812a, 812b, . . . , 812n) into the surface layer 808 as well as into the formation 810.

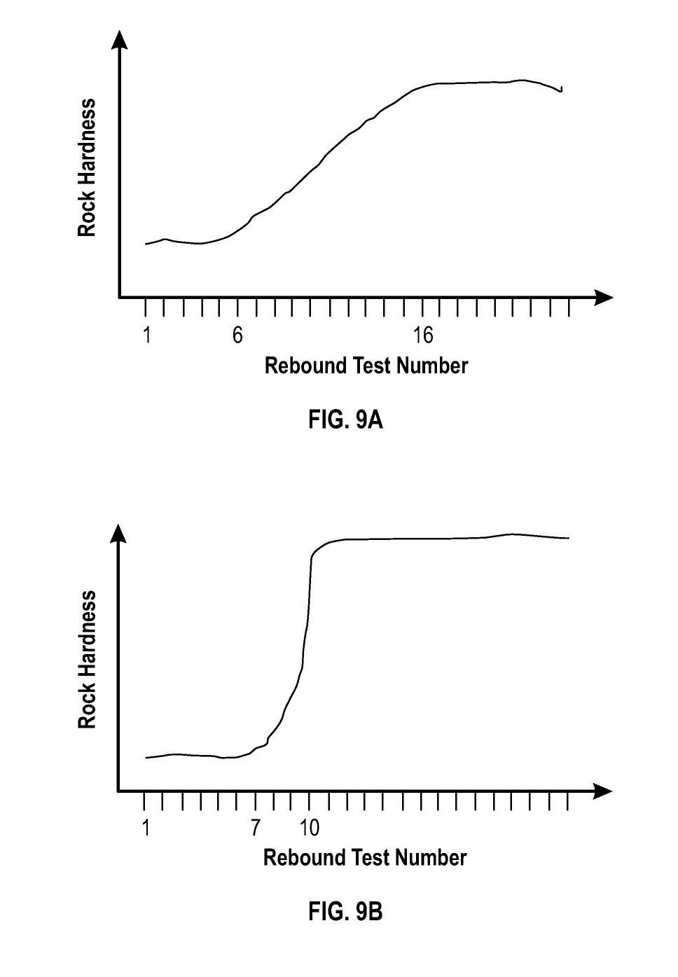

FIGS. 9A and 9B show illustrative relations between measured rock hardness values and numerical order of rock hardness tests for the RHMD 804 of FIG. 8. The relations shown in FIGS. 9A and 9B can also be converted into relations of rock strength with numerical order of rock hardness tests by using the conversion methods disclosed above with respect to FIGS. 5 and 6A-6D. Also, measurements can used to present a relation of rock hardness to distance into the formation 810 and/or surface layer 808 or a relation of rock strength to distance into the formation 810 and/or surface layer 808. The hardness values can be read and processed at a processor to determine a property of the surface layer 808 and of the formation 810. The determined parameter can be used with a measurement of another parameter of the formation (e.g., gamma ray measurements) in order to identify the composition of the surface layer 810 and of the formation 810.

FIG. 9A shows an illustrative relation between rock hardness values and a rebound test number. In FIG. 9A, rock hardness is shown along the y-axis and rebound test number is shown along the x-axis. A first subset of the rock hardness values includes a first few rock hardness values (hardness test numbers 1 through 6) which are indicative of hardness of the surface layer 808. A first subset of the rock hardness values includes later rock hardness values (i.e., rebound test numbers 16 and upward) which are indicative of hardness of material of the formation 810. The gradation of the rock hardness values with depth (i.e., between rebound test numbers 6 and 16) is indicative of a transition region between the surface layer 808 and the formation 810 and can be used to determine a property of at least the surface layer 808. For example, the transition region (between rebound test numbers 6 and 16) shows a gradual gradient between the low hardness values of the surface layer 808 to the higher hardness values of the formation 810. A gamma-ray measurement of the formation may indicate that the formation is a shale formation. Thus, one can conclude from the gradual gradient that the surface layer 808 includes hydration-softened shale.

FIG. 9B shows another relation between rock hardness values and rebound test number. In FIG. 9B, rock hardness is shown along the y-axis and rebound test number is shown along the x-axis.

Rock hardness values for the surface layer 808 (i.e., rebound test numbers 1 through 7) are small while rock hardness values for the formation 810 (i.e., rebound test numbers 10 and upward) are relatively high. The transition region (i.e., rebound test numbers 7 through 10) shows a fast gradient between the low hardness values of the surface layer 808 and the high hardness values of the formation 810. A gamma-ray measurement of the same location may indicate that the formation is a non-shale formation. Thus, one may conclude from the fast gradient in the transition region defined by rebound test numbers 7 through 10 that the surface layer 808 includes a layer of mud cake.

In another aspect, the present invention provides a method of detecting rock hardness at multiple distances into the formation 810. As discussed above with respect to FIG. 2, the RHMD 167 includes an ability to propel its piston 202 at a plurality of kinetic energies. At different kinetic energies, The impact energy will propagate to different depths into the formation 810 and thus the energy reflected back to the piston 202 and into its rebound will come from different depths into the formation 810.

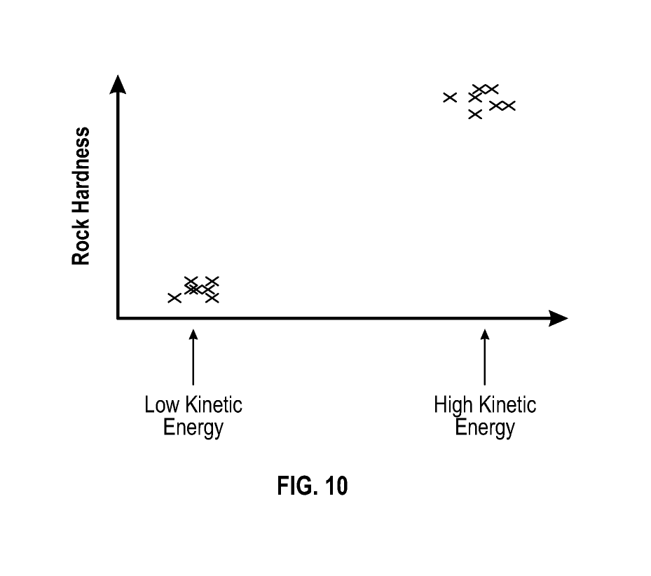

FIG. 10 shows a plot of between rock hardness values vs. kinetic energy of the piston 202 of the RHMD 167. Low kinetic energy impacts are recorded at a left side of the chart and high kinetic energy impacts are recorded at a right side of the chart. The hardness measurements obtained using low kinetic energy impacts are generally indicative of the hardness of the surface layer 808. The hardness measurements obtained using high kinetic energy impacts are generally indicate of the hardness of the formation 810. The hardness of additional layers can also be distinguished using different levels of kinetic energy of the piston 202.

Set forth below are some embodiments of the foregoing disclosure:

### Embodiment 1

A method of estimating a rock strength of a formation, including: conveying a tool having a testing surface into a wellbore in the formation; propelling the testing surface from the tool along a selected direction to impact the formation; obtaining a measurement of hardness of the formation from a rebound of the testing surface from the formation; measuring a value of a lithological property of the formation using a downhole sensor; using the value of the lithological property of the formation to select a relation between the selected rock hardness and the rock strength of the formation; and determining the rock strength of the formation from the measurement of rock hardness and the selected relation between the rock hardness and rock strength.

### Embodiment 2

The method of embodiment 1, further including using the determined rock strength profile of the formation to perform at least one of (i) altering a drilling parameter to steer a drill string along a selected drill path; (ii) altering a drilling parameter to affect a measure of drilling performance; and (iii) design at least one element of a drilling system for drilling the wellbore.

### Embodiment 3

The method of embodiment 1, wherein the testing surface is configured to be propelled and to rebound from the formation multiple times at a selected location of the wellbore in order to determine a profile of rebound hardness with respect to a distance into the formation from a wall of the wellbore.

### Embodiment 4

The method of embodiment 1, wherein the testing surface is configured to be propelled against the formation at a plurality of kinetic energy in order to determine a profile of rebound hardness with respect to a distance into the formation from a wall of the wellbore.

### Embodiment 5

The method of embodiment 1, further including conveying the tool downhole using one of: (i) a drill string; (ii) a wireline; and (iii) a coiled tubing.

### Embodiment 6

A method of developing a formation, including: determining a rock strength of the formation at a selected location in a wellbore from a rock hardness measurement obtained by propelling a testing surface at the selection location; obtaining a measurement of geomechanical stress and a measurement of pore pressure at the selected location; and using a processor to: build a model of the formation using the rock strength, the geomechanical stress and the pore pressure at a plurality of depths, and develop the formation using the model of the formation.

### Embodiment 7

A method of determining a property of a formation, including: propelling the testing surface from a tool in a wellbore a plurality of times to impact the formation at a selected location, wherein the formation includes a surface layer at an interface of the formation and the wellbore; for each of the plurality of impacts, obtaining a measurement of hardness of the formation at the selected location in the wellbore; obtaining a profile of rock hardness measurements with distance into the formation from the plurality of measurements of hardness; and determining the property of the surface layer from a first subset of the measurements of hardness and the property of the formation from a second subset of the plurality of hardness measurement.

### Embodiment 8

A method of obtaining a hardness profile of a formation, including: propelling a testing surface in a wellbore penetrating the formation to impact the formation at a selected location at a first energy to obtain a first rock hardness measurement at the selected location; propelling the testing surface to impact the formation at the selected location at a second energy to obtain a second rock hardness measurement at the selected location; and determining a property of a surface layer on a wall of the wellbore at the selection location from the first rock hardness measurement and a property of the formation at the selection location from the second rock hardness measurement.

While the foregoing disclosure is directed to the preferred embodiments of the disclosure, various modifications will be apparent to those skilled in the art. It is intended that all variations within the scope and spirit of the appended claims be embraced by the foregoing disclosure.

What is claimed is:

1. A method of estimating a rock strength of a formation, comprising:
conveying a tool having a testing surface into a wellbore in the formation;
propelling the testing surface from the tool along a selected direction to impact the formation;
obtaining a measurement of hardness of the formation from a rebound of the testing surface from the formation;
measuring a value of a lithological property of the formation using a downhole sensor;
using the value of the lithological property of the formation to select a relation between the selected rock hardness and the rock strength of the formation; and
determining the rock strength of the formation from the measurement of rock hardness and the selected relation between the rock hardness and rock strength.

2. The method of claim 1, further comprising using the determined rock strength profile of the formation to perform at least one of (i) altering a drilling parameter to steer a drill string along a selected drill path; (ii) altering a drilling parameter to affect a measure of drilling performance; and (iii) design at least one element of a drilling system for drilling the wellbore.

3. The method of claim 1, wherein the testing surface is configured to be propelled and to rebound from the formation multiple times at a selected location of the wellbore in order to determine a profile of rebound hardness with respect to a distance into the formation from a wall of the wellbore.

4. The method of claim 1, wherein the testing surface is configured to be propelled against the formation at a plurality of kinetic energy in order to determine a profile of rebound hardness with respect to a distance into the formation from a wall of the wellbore.

5. The method of claim 1, further comprising conveying the tool downhole using one of: (i) a drill string; (ii) a wireline; and (iii) a coiled tubing.

6. A method of developing a formation, comprising:
determining a rock strength of the formation at a selected location in a wellbore from a rock hardness measurement obtained by propelling a testing surface at the selection location;
obtaining a measurement of geomechanical stress and a measurement of pore pressure at the selected location; and
using a processor to:
build a model of the formation using the rock strength, the geomechanical stress and the pore pressure at a plurality of depths, and
develop the formation using the model of the formation.

7. The method of claim 6, wherein the rock hardness measurement is obtained by conveying a tool having the testing surface into the wellbore.

8. The method of claim 6, wherein the tool further comprise a sensor for measuring a parameter indicative of geomechanical stress and a sensor for measuring a parameter indicative of pore pressure.

9. The method of claim 6, wherein developing the formation further comprises at least one of (i) geo steering a drill string; (ii) altering a drilling parameter to improve a measure of drilling performance; and (iii) design at least one element of a drilling system for drilling the wellbore.

10. A method of determining a property of a formation, comprising:
propelling the testing surface from a tool in a wellbore a plurality of times to impact the formation at a selected location, wherein the formation includes a surface layer at an interface of the formation and the wellbore;
for each of the plurality of impacts, obtaining a measurement of hardness of the formation at the selected location in the wellbore;
obtaining a profile of rock hardness measurements with distance into the formation from the plurality of measurements of hardness; and
determining the property of the surface layer from a first subset of the measurements of hardness and the property of the formation from a second subset of the plurality of hardness measurements.

11. The method of claim 10, wherein the formation is a shale formation and the first subset is indicative of the surface layer including hydrated shale.

12. The method of claim 10, wherein the formation is a non-shale formation and the first subset is indicative of the surface layer including a mudcake layer.

13. The method of claim 9, further comprising determining a property of at least one of the surface layer and the formation from a gradient of hardness measurements with distance into the formation.

14. The method of claim 9, further comprising using a formation sensor to measure a parameter of the formation indicative of a lithology of the formation and determining the property of the surface layer from the measured parameter of the formation and the plurality of rock hardness measurements.

15. A method of obtaining a hardness profile of a formation, comprising:
propelling a testing surface in a wellbore penetrating the formation to impact the formation at a selected location at a first energy to obtain a first rock hardness measurement at the selected location;
propelling the testing surface to impact the formation at the selected location at a second energy to obtain a second rock hardness measurement at the selected location; and
determining a property of a surface layer on a wall of the wellbore at the selection location from the first rock hardness measurement and a property of the formation at the selection location from the second rock hardness measurement.
